(19) United States
(12) Patent Application Publication
(10) Pub. No.: US 2017/0207592 A1
(43) Pub. Date: Jul. 20, 2017

(54) CONTACTLESS ELECTRICAL CURRENT TRANSFER APPARATUS WITH DIAMOND AND OTHER EMITTER STRUCTURES AND HOMOPOLAR MACHINES COMPRISING SAME

(71) Applicant: Advanced Magnet Lab, Inc., Palm Bay, FL (US)

(72) Inventor: Rainer Meinke, Melbourne, FL (US)

(73) Assignee: Advanced Magnet Lab, Inc., Palm Bay, FL (US)

(21) Appl. No.: 15/408,153

(22) Filed: Jan. 17, 2017

Related U.S. Application Data
(60) Provisional application No. 62/278,980, filed on Jan. 14, 2016.
(60) Provisional application No. 62/435,146, filed on Dec. 16, 2016.

(51) Int. Cl. H01R 39/64; H01R 39/02; H02K 31/00

(52) U.S. Cl. CPC H01R 39/64; H02K 31/00; H01R 39/02

(57) ABSTRACT

Microemitter arrays comprising a plurality of microemitters having current transfer features such as microtips or blades to form contactless current transfer structures, and homopolar machines comprising same, are described and claimed. The invention further defines homopolar motors or generators comprising electrical connections formed of electrodes that transfer current without mechanical contact. Micron-size electron field emitters offer contact-free current transfer with high longevity, high reliability and are insensitive to temperature and if needed ionizing radiation. The microemitters may comprise diamond material and may be placed in a vacuum or noble gas environment. The gap between microemitters and electrodes for efficient, reliable current transfer could be in the range of 0.5 to 2 mm. The current transfer can be accomplished without mechanical contact, enabling higher RPM motors than previously achievable with brush or liquid metal electrical connections.

### NON-PROVISIONAL APPLICATION FOR PATENT UNDER 35 USC 111(a)

### CROSS REFERENCE TO RELATED APPLICATIONS AND INCORPORATION BY REFERENCE

This non provisional patent application is a non-provisional of and claims the benefit of U.S. provisional patent application 62/278,980, filed in the United States Patent Office (USPTO) on Jan. 14, 2016 titled ELECTRICAL CURRENT TRANSFER APPARATUS, which is hereby incorporated by reference in its entirety, and this application also claims the benefit of U.S. provisional patent application 62/435,146, filed in the United States Patent Office (USPTO) on Dec. 16, 2016 titled ELECTRICAL CURRENT TRANSFER APPARATUS WITH DIAMOND AND OTHER EMITTER STRUCTURES, which is hereby incorporated by reference in its entirety.

U.S. Pat. Nos. 6,762,543 and 7,256,535 are both herein incorporated by reference in their entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The field of the invention relates generally to systems and methods for transfer of electric current without mechanical contact between conductors and homopolar machines comprising same. More specifically, the field is further defined as the use of microemitter arrays comprising a plurality of microemitters having current transfer features such as microtips or blades to form contactless current transfer structures, and homopolar machines comprising same.

2. Background Art

The ability to conduct a current between two structures in a controlled manner has many useful applications. Some of these applications, such as, for example, homopolar motors, are discussed in exemplary fashion herein. The implementation of a homopolar motor may require the transfer of large DC currents across a rotating or sliding (i.e. translating) mechanical connection forming electrical contact. Such connections are unreliable and may pose limitations on the rotational speed at which the structure operates.

Reliable transfer of large direct currents (DC) without mechanical contact has important applications in many areas. One application where this technology is expected to have a major impact is turbo-electric propulsion, which has been identified as a key technology for future transportation aircrafts. Turbo-electric propulsion technology offers advantages in respect to efficiency and furthermore leads to significant noise and emission reduction. However, the requirements on the propulsion system are very challenging and can only be met by superconducting (SC) machines with unprecedented power density. Fully superconducting synchronous machines are considered as a possible solution, but are very difficult to realize, partially due to high AC losses in the armature windings at the necessary high RPM of the required machines. Homopolar machines, on the other hand, would avoid many of the technical challenges encountered in the realization of fully superconducting synchronous machines, could offer unprecedented power density, but require high current transfer over sliding contacts, which so far has been a showstopper for the development of homopolar machines. However, if a solution can be found for the required transfer of large DC currents into a rotating system with longevity, high reliability and efficiency, homopolar machine technology would constitute a “game-changing” technology.

### BRIEF SUMMARY OF THE INVENTION

The present invention comprises an apparatus and method that have one or more of the following features and/or steps, which alone or in any combination may comprise patentable subject matter, and which provide substantial advantages over the prior art.

In accordance with one embodiment of the present invention, the invention comprises an apparatus for conducting electric current without mechanical contact, eliminating or drastically reducing the problems associated with sliding or rotating electrically conductive mechanical contact which are significant drawbacks of the prior art. In an embodiment, a plurality of microemitters, which may be fabricated from diamond or other appropriate materials, are proximal to, but not in physical contact with, at least one electrically conductive electrode having a surface area. The gap between each of the plurality of microemitters and the at least one electrically conductive electrode operates to allow the plurality of microemitters and the at least one electrically conductive electrode to be translated relative to each other, forming a contactless electrically conductive emitter-electrode structure, enabling the conduction of electric current between two mechanical structures that are translating or rotating relative to one another.

An exemplary embodiment of the invention comprises a contactless electrically conductive emitter structure of the invention in which one such mechanical structure is a rotor of a homopolar motor, and the other mechanical structure is the stator of a homopolar motor, and which the stator comprises the emitter structure and the rotor comprises the electrode structure in electrical communication with the emitters of the stator. In this exemplary embodiment electrical current is transferred from rotor to stator across the gap between each of the emitters and the electrode(s), enabling the rotor to rotate relative to the stator while at the same time conducting an electric current across the contactless electrically conductive emitter-electrode structure.

In a homopolar motor of the invention large DC currents in the range of 3,000 to 80,000 A or even higher can be transferred between the edge of a rotating disk or ends of a rotating cylinder and a stationary electrode.

Thus the present invention enables a highly reliable and efficient apparatus for the transfer of large DC currents into a rotating system, such as, for example, homopolar machines. An embodiment of the invention is a homopolar machine, which may be a motor or generator, which contains at least one, or, generally, a plurality, of the contactless electrically conductive emitter structure of the invention.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1A depicts a Faraday disk in the presence of a static magnetic field as may be utilized in a homopolar machine embodiment of the invention.

FIG. 1B depicts a cross section of a disk-type homopolar machine of the invention.

FIG. 1C depicts a cross section of a drum-type homopolar machine of the invention.

FIG. 2A depicts a schematic view of a disk-type homopolar machine of the invention.

FIG. 2B depicts an end view of a stator to rotor contactless electrically conductive emitter-electrode structure, enabling the contactless conduction of electric current between the rotor and the stator of a homopolar machine.

FIG. 2C depicts a cross section view of a rotor shaft contactless electrically conductive emitter-electrode structure, enabling the contactless conduction of electric current between a rotor shaft and an electrical contact in a homopolar machine. In the example depicted, the electrical contact is used to inject electric current into the rotor shaft.

FIG. 3A depicts an exemplary microemitter array of the invention.

FIG. 3B depicts an exemplary pyramid-style microemitter of the invention.

FIG. 4 depicts a schematic view of contact-free current transfer into a rotating disk, or rotor.

FIG. 5 depicts a schematic layout of homopolar machine with rectifier housed inside of the rotating cylinder.

### DETAILED DESCRIPTION OF THE INVENTION

As used herein, “disc” and “disk” have the same meaning.

As used herein, “cylinder” and “drum” have the same meaning.

As used herein, “SC” means superconducting.

As used herein, “DC” means direct current and “AC” means alternating current.

It is an object of the invention to enable the contactless transfer of electric current from a first structure to a second structure, the electric current being transferred across a gap between the first and second structures, and the current being passed through an array of microemitters as described herein and as described in the referenced and incorporated documents. Thus, the contactless transfer of current between two structures which are translating or rotating, or both, relative to one another is achieved with the benefit of eliminating the problems associated with physical or mechanical contact wear-out.

It is a further object of the invention to claim electric machines that comprise the contactless transfer of electric current as described herein. One such class of machines is homopolar machines.

### Homopolar Machines

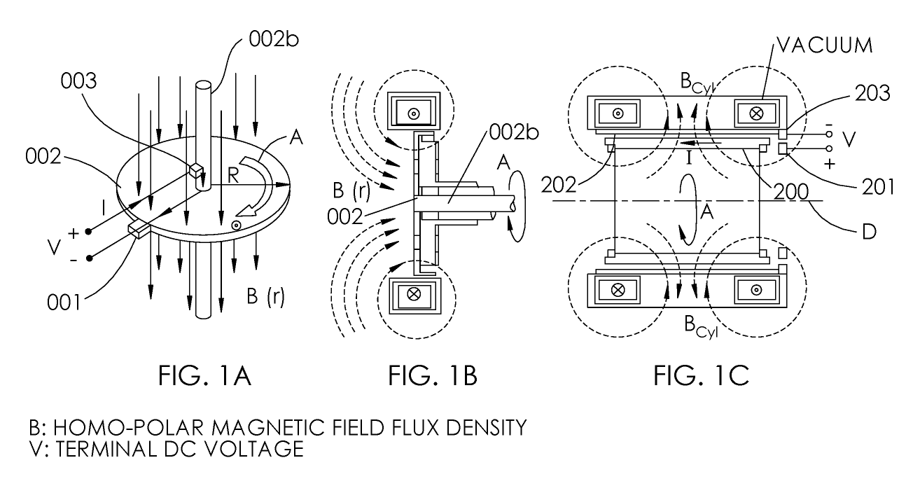

In the simplest form, homopolar electrical machines consist of an electrically conductive disc or cylinder rotating in a plane perpendicular to a uniform static magnetic field. In case of a generator a potential difference is created between the center of the disc and the rim (or ends of the cylinder) with an electrical polarity that depends on the direction of rotation and the orientation of the field. In case of a motor the potential difference is applied, leading to a current through the disk or cylinder, which creates a Lorentz force in the magnetic field, causing the disk or cylinder to rotate. The two cases consisting of a disk or a cylinder or drum, are schematically shown in FIGS. 1A-1C.

Referring now to FIGS. 1A and 1B, a disk-type homopolar machine is schematically depicted. Rotating conductive disk 002 is in the presence of magnetic field B(r), with flux lines as depicted. Electric current I resulting from applied voltage V (in the case of a homopolar motor) cuts across magnetic lines of flux B, causing disk 002 to rotate in the direction depicted by arrow A. The same physical principles apply to the drum-type homopolar machine depicted in FIG. 1C. Again, in the case of a homopolar motor, applied voltage V causes current I to flow in conductive drum 200. Current I cuts across magnetic lines of flux B, causing drum 200 to rotate.

In any of the embodiments shown and described, the current transfer between rotating surfaces may be accomplished by the contactless current transfer structured described herein and in the references that are incorporated by reference. Furthermore, any of the homopolar machines described herein may operate as a motor, wherein an applied magnetic field causes a disc or drum to rotate when current is passed through the disc or drum, or may operate as an electric current generator in which a rotating conductive disk or drum, in the presence of a magnetic field, generates an electric current.

The governing equations of a homopolar generators i.e., the induced voltage and power, Faraday's conductive disk, where angular velocity Ωₘ=2πn, for a rotationally symmetric magnetic field B(r), are presented below. Eq. 1 provides the relationship for the induction of motion; Eq. 2 provides the relationship for an induced DC voltage.

$$\begin{matrix}\vec{{E}_{b}} = \vec{vx} \vec{B} \to {E}_{b} ( r ) = v ( r ) \cdot B ( r ) = {Ω}_{m} r \cdot B ( r ) & Eq . 1 \\ {U}_{i} = {\int }_{0}^{R} \vec{{E}_{b}} \cdot d \vec{s} = {\int }_{0}^{R} {E}_{b} ( r ) dr = {\int }_{0}^{R} {Ω}_{m} B ( r ) rdr & Eq . 2\end{matrix}$$

Power conversion for B(r) with a mean value B estimated is provided by the relationship shown in Eq. 3:

Uᵢ=Ωₘ·B·R²/2→Pᵢ=UᵢI Eq. 3

The excitation windings can be, but are not necessarily, produced of superconducting material.

The homopolar concept overcomes key issues inherent to superconducting synchronous machines and therefore has the potential to be the preferred solution of future superconducting machines. While the field in the air gap of a synchronous machine is practically limited to 2 Tesla, because of saturation of the required back iron, homopolar machines benefit from the highest field possible, and fields of 6 Tesla or even much higher are feasible. In this respect the homopolar concept makes full use of superconductivity, which enables high fields without a penalty in efficiency. Also AC losses in the armature winding, a major issue of fully superconducting synchronous machines, are non-existent in homopolar machines, and applications like various propulsion systems typically experience strong vibrations (car, airplane, etc.) that can cause significant eddy current losses in cryostat walls and any surrounding metal surfaces which increase with the RPM. In contrast, for a homopolar machine the current and resulting Lorentz forces are practically constant and the higher the RPM the better for the operation, since the currents needed for a required power level are reduced. Furthermore the field winding configuration of a homopolar machine is much simpler than those of synchronous machines, i.e., solenoidal windings instead of saddle or racetrack coils. Tape conductors like REBCO (rare earth barium copper oxide) are well suited for homopolar machines, enabling operational temperatures in the range of 30 K or even approaching 77 K. Relatively small cryo-coolers with high efficiency are therefore sufficient to produce the required operational temperature. Additional advantages of the homopolar concept include reduced torque ripple, increased mechanical robustness of the windings, and simpler handling of various fault conditions like quench protection of the field coils.

Homopolar machines in contrast to most other electrical machines require that all of the machine power has to be transferred through a current collection system, typically consisting of brushes. This necessarily involves current transfer across a sliding interface. Such current transfer system with sufficient longevity, high reliability, low friction, and low electrical losses constitutes a major technological hurdle that has so far hampered the widespread use of homopolar machines. Sliding/rolling contacts constitute a technical issue for homopolar machines. Such contacts put limitations on the RPM, i.e., the relative speed of the sliding contacts and also limit the amount of current that can be transferred per contact. If moving contacts could be eliminated, homopolar machines would be preferred over synchronous machines for many applications.

Homopolar machines have some unique features that make them of great interest for many applications. One of these is that there is no armature reaction of the applied current on the field windings, since they are orthogonal, which is of particular interest for a superconducting field coils, where such interaction can cause quenching of the superconducting coils. Additionally there is very low electrical noise generated by the machine, which also is of interest for particular applications. While synchronous machines typically require back iron, which saturates at a maximum of two Tesla and therefore limits the field that can be used in the airgap between rotor and stator, for homopolar machines the higher the field the better. If the current transfer onto the rotating system does not compromise the operation of the homopolar machine, very high RPMs are feasible and no special electronics or starter is required to start the homopolar machine as needed for synchronous or induction machines.

Some of the advantages of a homopolar machine can be summarized as follows: simplified machine design; fixed DC superconducting excitation coil; simple coil design with HTS conductor; high excitation fields possible 5 Tesla and higher; DC output, no rectification required, direct feed to power transfer line; and a room temperature rotor system.

### Conventional Current Transfer Solutions

One possibility for the current transfer to the rotor of a homopolar machine is the application of electrical brushes. However, brushes introduce mechanical and electrical losses and also introduce lifetime issues. As a general rule several performance factors need to be balanced or compromised. The electrical voltage drop multiplied by the current transferred by a given brush defines the electrical portion of the power dissipation and needs to be minimized. The friction coefficient of the sliding interfaces depending on sliding speed (proportional to the RPM) and the brush pressure defines mechanical losses and needs to be minimized Typically the brushes are designed with equal amounts of electrical and mechanical losses. Brush life and slip ring life need to be optimized. Brush environment which can depend on temperature, surrounding atmosphere, wear debris management need to be considered.

Liquid metals or other liquids with high electrical conductivity constitute an alternative solution for the current transfer problem. In fact, the first electrical machine invented by Faraday around 1821 used liquid mercury to make contact between the circumference of a rotating disk and its shaft. Various liquid metals have been considered as a replacement for the mercury, which due to its toxicity makes it nowadays unacceptable. However, all potential liquids require careful control of the operational temperature and the surrounding atmosphere. Additionally, the unavoidable losses caused by the viscosity of the liquid constitute the main problem and limitation for high RPM.

### Micro-Patterned Contactless Electric Current Transfer Structure of the Invention

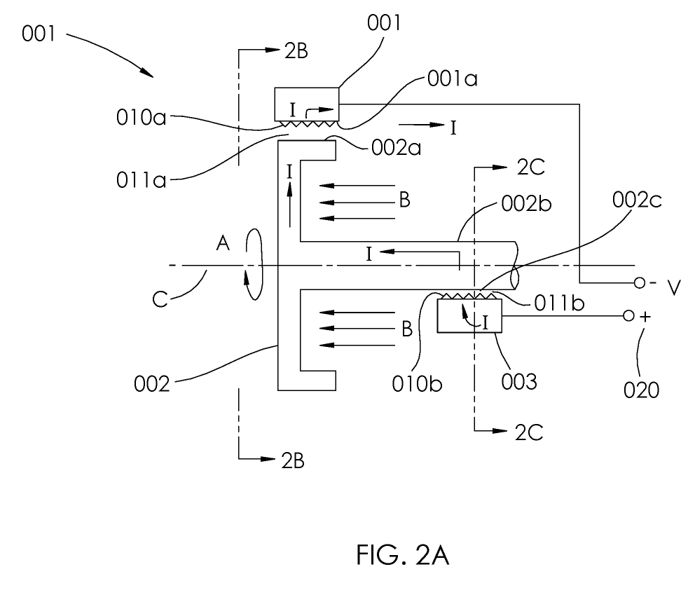

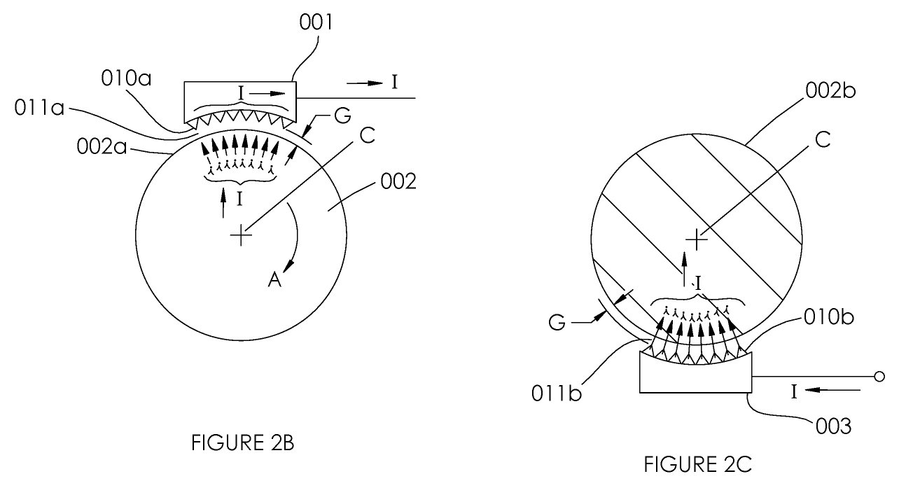

The present invention utilizes microemitter arrays comprising a plurality of, for example, micron-size electron field emitters resulting in contact-free current transfer of electric current to a nearby electrode, forming a contactless electric current transfer structure with high longevity, high reliability and are insensitive to temperature and if needed ionizing radiation. In the invention, depicted in exemplary fashion in FIGS. 1A-1C, large DC currents in the range of 3,000 A to 80,000 A can be transferred between the edge of rotating disk and a stationary electrode. The current transfer can be accomplished without mechanical contact using the emitter structure of the invention. The distance, or gap G as shown in FIGS. 2B and 2C, between the opposing electrodes for efficient, reliable current transfer could be in the range of 0.5 to 2 mm This gap, for example, is the distance between the microemitter tip and the surface of the electrode to which is conducting electric current i. The contactless current transfer structure of the invention may thus comprise an array of a plurality of microemitters, each microemitter having a current transfer feature, such as a microtip or blade structure as defined herein or in U.S. Pat. No. 6,762,543 or U.S. Pat. No. 7,256,535, separated from a surface of an electrode which is in contactless electrical communication with the emitters of the emitter array by a predetermined gap G (see FIGS. 2B and 2C), the gap G being of any dimension operable to allow the conduction of electric current between the emitter microtip and the surface of the electrode, but is typically 0.5mm to 2.0mm. The contactless electric current transfer structures of the invention may, in some embodiments, be contained in a low-pressure gas or vacuum environment. For the low pressure case the volume surrounding the contactless electric current transfer structures can be filled with an inert gas such as argon or helium. FIGS. 1A, 1B, and 1C depict generalized exemplary embodiments of homopolar machines of the invention.

Thus, in a most general form, the contactless electric current transfer structure of the invention is for communicating electric current between two structures that are able to be translated or rotated relative to one another, and has a first structure which may be, for example, a rotor or stator electrode, having a plurality of microemitters forming a microemitter array, each microemitter defined has having a current transfer feature such as a microtip or blade tip; a second structure, such as a rotor or stator electrode, having a conductive surface forming an electrode; and a magnetic field B defined by magnetic lines of flux; wherein a predetermined gap G exists between the current transfer feature of each microemitter and said electrode such that contactless electric current transfer is able to occur between the microemitter current transfer feature and the electrode; and wherein said first structure (e.g. rotor 002 or 200) is capable of being rotated or translated relative to said second structure such that, during said rotation or translation, said predetermined gap G between the current transfer feature and said electrode is maintained.

Likewise, in its most general form, a homopolar machine of the invention comprises a rotor portion, a stator portion, and a magnetic field defined by magnetic field lines B(r), in which the rotor is in electric communication with a rotor electrode through a contactless electric current transfer structure of the invention and the stator is in electric communication with the rotor through a contactless electric current transfer structure of the invention, and in which an electric current, which may be but is not necessarily a DC current, is passed through the rotor electrode into the rotor, and along the rotor and into the stator, and wherein the electric current has a direction of current path that is substantially orthogonal to the magnetic field lines. In a homopolar motor of the invention the current is caused to flow by applying a voltage differential across the rotor electrode and the stator electrode, causing Lorentz forces to act on the rotor, in turn causing the rotor to rotate about a longitudinal axis. In a homopolar generator of the invention, the rotor may be mechanically rotated by a rotating force, causing the generation of current I as the conductive rotor is rotated in the presence of magnetic field B(r).

Still referring to FIGS. 1A and 1B, a Faraday disk in the presence of a magnetic field, which may be static, is depicted. Conductive rotor 002, depicted in exemplary fashion as a disk in the figure, is subject to magnetic field having lines of flux B(r). Rotor electrode 003 is in contactless electric communication with rotor 002 and conducts electric current I into rotor shaft 002b through a contactless electric current transfer structure of the invention in which an emitter array of the invention is in contactless electrical communication with an electrode area on rotor shaft 002b, wherein the microtips of the emitters comprising rotor electrode 003 are separated from the electrode area on rotor shaft 002b by gap G as shown in FIGS. 2B and 2C. Current I is conducted along rotor shaft 002b into rotor disk 002, and then in a path across conductive rotor 002 to electrode area 002a. Rotor disk 002 may be but is not necessarily a disk of radius R. Current I then passes to stator electrode 001 which is in electrical communication with rotor 002 through a contactless electric current transfer structure of the invention in which an emitter array is disposed on stator electrode 001, the emitters being in contactless electrical communication with an electrode area 002a on rotor disk 002, wherein the microtips of the emitters on the stator emitter array are separated from the electrode area 002a on rotor disk 002 by a predetermined gap G (depicted in FIGS. 2B and 2C) that is maintained as rotor disc 002a rotates about longitudinal axis C such that contactless transfer of electric current between rotor 002a and stator 001 is achieved. Current I may cut through magnetic field lines B(r) along a path in rotor 002 that is substantially orthogonal to magnetic flux lines B(r). Rotor shaft 002b may rotate in the direction of arrow A about longitudinal axis C, which forms a longitudinal axis of rotor shaft 002b. In the case of a homopolar motor, current I is generated by an applied voltage V causing current I to flow as described in the presence of magnetic field lines B(r) causing rotor 002 to rotate. In the case of a homopolar generator, current I is generated by an applied rotational force causing rotor 002 to rotate within the applied magnetic field B(r), generating current I.

In FIG. 1C, a drum-type homopolar machine of the invention is depicted. In the case of a homopolar motor, electric current I is communicated into conductive inner drum 200 by application of voltage V to drum electrical contact 201, which comprises an emitter array of a contactless electric current transfer structure of the invention and is in contactless electrical communication with an electrode area located on inner drum 200, allowing current I to pass into conductive inner drum (rotor) 200. Current I flows through conductive inner drum (rotor) 200 to the opposing end of drum (rotor) 200 in the presence of magnetic field B_{cyl}. Inner drum 200 is the rotor of the homopolar machine, and is operable to rotate about longitudinal axis D in the direction of arrow A. Current I is conducted along inner drum 200 to an electrode area located preferably, but not necessarily, on an opposing end of drum 200 where it passes through an electrode area of contactless electric current transfer structure into stator 202, which comprises a emitter array for contactless transfer of current I from inner drum (i.e. rotor) 200 to outer drum (stator) 202 allowing electric current I to be conducted in contactless fashion into stator drum 202. The rotor electrode area and the emitter tips of the emitter array located on stator 202 are separated by a predetermined gap G (depicted in FIGS. 2B and 2C), that is maintained as inner drum (rotor) 200 rotates about longitudinal axis D within outer drum (stator) 202 such that contactless transfer of electric current between inner drum (rotor) 200 and outer drum (stator) 202 is achieved. It is not necessary that stator 202 be a drum configuration. Current I may cut through magnetic field lines B_{cyl} as it passes along a path in rotor drum 200 that is substantially orthogonal to magnetic flux lines B_{cyl}. Current I is the conducted through conductive stator drum 202 to stator electrical connection 203, which may comprise a part of the electrical connection applying voltage V to the homopolar machine (in the case of a homopolar motor). In the case of a homopolar generator, current I is generated by an applied rotational force causing inner drum (rotor) 200 to rotate within the applied magnetic field B_{cyl}, generating current I.

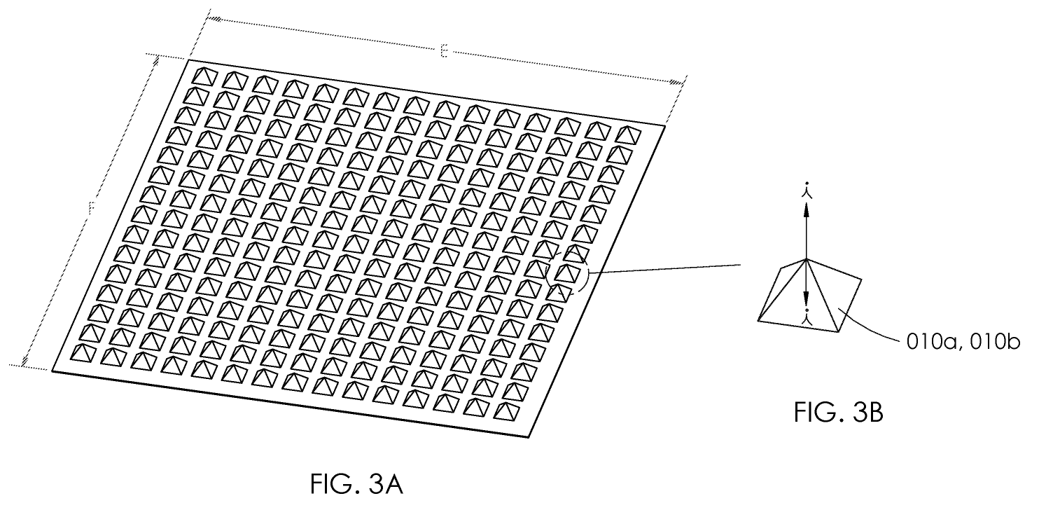

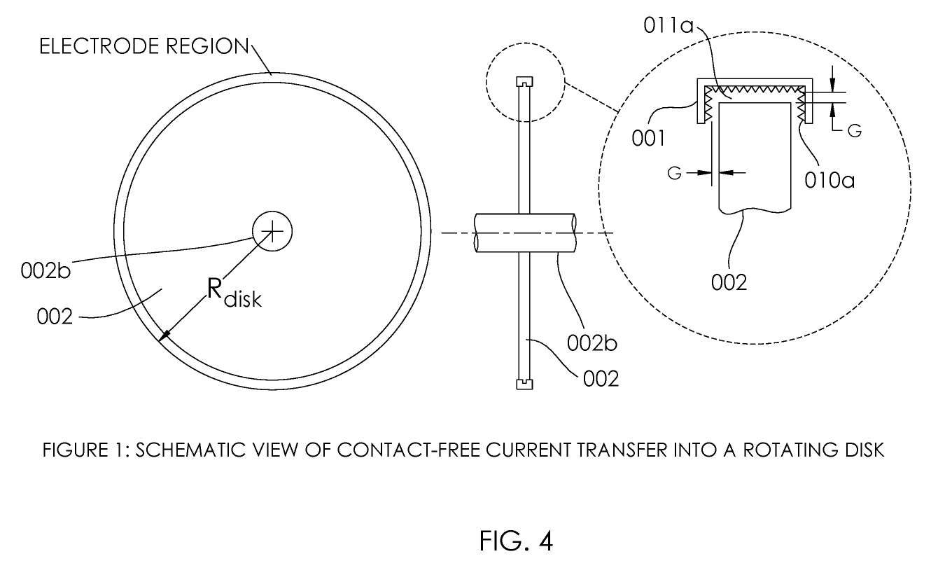

Referring now to FIG. 2A, a schematic view of an embodiment of a homopolar motor of the invention is depicted. In this embodiment, which correlates to the embodiment depicted in FIGS. 1A and 1B, direct current I is passed though stator electrode 003 into shaft 002b through microemitter array 010b transferring current to rotor shaft electrode area 002c. Microemitter arrays 010a and 010b are comprised of a plurality of microemitters as is further depicted in FIGS. 3A and 3B. Direct current I, which (in the case of a homopolar motor) results from applied voltage V, passes into and through conductive rotor shaft 002b by operation of the microemitter array 010b. Current I then flows along the shaft in an axial direction and across rotor disk 002 through rotor disk electrode area 002a into the microemitter array 010a on stator electrode 001 in the presence of magnetic field lines of flux B. Current I cuts across magnetic field lines of flux B as it passes through rotor disc 002. Direct current I then passes through a plurality of microemitters in microemitter array 010a into stator electrode 001. The applied magnetic lines of flux B interact with direct current I to cause rotor 002 to rotate in the direction A.

Referring now to FIG. 2B, an expanded view of the microemitter contactless current transfer area 010a of the invention, in which electric current I passes from rotor 002 through rotor disc 002, across rotor disc current transfer area 002a, through the plurality of microemitters forming microemitter array 010a which are in electrical communication with stator electrode 001 in contactless fashion, is depicted. Elements of current I, depicted as i in FIG. 2B, each pass through a microemitter of microemitter array 010a. The sum of currents i equals the total current I minus any electrical losses in the microemitter current transfer or resistive losses in the conductive path through rotor disc 002 or rotor shaft 002a. As current I passes through rotor disc 002 in the presence of magnetic field lines of flux B, Lorentz forces cause rotor disc 002 to rotate in the direction indicated by arrow A. A description of the plurality of microemitters comprising microemitter array 010a is further provided in FIG. 3. Thus contactless current transfer occurs across predetermined gap G. Rotor disk 002a and 002b rotate about longitudinal axis C.

In an embodiment, the entire rim edge 002a of the disk at the disk edge may serve as an electrode area. As an exemplary implementation of the invention, assuming a disk radius R_{disk} of 250 mm, a thickness W of 25 mm and a radial extension L of 10 mm yields a total electrode area of about 70,000 mm². For larger dimensions with R_{disk} of 500 mm, a thickness W of 50 mm and a radial extension L of 20 mm, the total available area increases to about 280,000 mm². For these dimensions, for example, a current of 80,000 A yields current densities of 1,100 mA/mm² and 300 mA/mm² respectively. For the lower current scenario of 3,000 A the required current densities are only 40 to 10 mA for the assumed electrode sizes.

The required current transfer can be facilitated by using any of the contactless current transfer structures as described in patents U.S. Pat. No. 6,762,543 and U.S. Pat. No. 7,256,535, which are both herein incorporated by reference in their entirety. The emitters may, but do not necessarily, comprise diamond material. As an example of one embodiment of the emitters of the invention, U.S. Pat. No. 6,762,543 describes emitter structures having current transfer features, such as a microtip current transfer feature, made from diamond or similar materials to establish ultra-sharp tips for efficient electron emission. For the current invention, the most desirable properties for an electron emission cathode are low operating voltage, for example 0.5 to 0.7 Volt, high emission current density, for example 100 A/cm2 to 400 A/cm2, uniformity, and emission stability, longevity and reliability. Contact-free, high current transfer for homopolar machines requires the same properties for best performance. The ranges shown are exemplary in nature, and are not intended to be limiting of Applicant's invention, but rather as preferred ranges. Based on these requirements it is understood that the emitter structures of the invention are not limited to diamond material, and that emitters comprising any other materials meeting the above specifications are within the scope of Applicants' invention.

The operational voltage for maintaining a current transfer may be any voltage, but a voltage of a few volts is sufficient, due to the very small dimensions of the microemitter discharge surface which may be a peak, blade or other structure, which give rise to very high electrical fields in their vicinity.

As for any current transfer technology the effective path resistance, i.e., the resistance across the current transfer has to be extremely small. The total losses due to the current transfer have to be less or equal 2.5×10⁻³. For a 1 MW system this would constitute a power loss of 2.5×10⁻³*1×10⁶=2.5×10³ W or 0.25% . The total resistance for the 80 kA current transfer has to be (P=R*I²) R=Pₗₒₛₛ/I², i.e., R≦2.5×10³/80,000²=3.9×10⁻⁷. For the low current version of 3,000 A the required resistance is R≦2.5×10³/3,000²=2.8×10⁻⁴. Typical operational parameters are summarized in the following table.

Key Parameters for Plasma Current Transfer

| Parameter | Unit | Value |
|---|---|---|
| Current to be Transferred | A | 3,000-80,000 |
| Current Density | mA/mm² | 10 to 1,100 |
| Electrode Voltage | V | 12.5, 48,380 |
| Electrode Area | mm² | 70,000-280,000 |
| Gap Distance | mm | TBD |
| Path Resistance | Ohm | 2.8 × 10⁻⁴-3.9 × 10⁻⁷ |
| Gas Composition (if needed) | Torr | TBD |
| Gas Pressure (if needed) | | TBD |
| Electrode Lifetime | years | >1 |

For very high RPM it is necessary to house the rotor (cylinder, drum or disk) inside of a vacuum to avoid large windage losses due to friction with any gas surrounding the rotor. For lower RPM a noble gas in the current transfer region could be advantageous, which would lead to a kind of plasma current transfer.

Referring now to FIG. 2C, an expanded view of the microemitter contactless current transfer area 010b of the invention, in which electric current I passes from electrode 003 into rotor shaft 002b is depicted. Elements of current I, depicted as i in FIG. 2C, each pass through a microemitter comprising microemitter array 010b. The sum of currents i equals the total current I minus any electrical losses in the microemitter current transfer or resistive losses in the conductive path through rotor disc 002 or rotor shaft 002a. A description of the plurality of microemitters comprising microemitter array 010a is further provided in FIGS. 3A and 3B. Thus contactless current transfer occurs across predetermined gap G. Rotor disk 002a and 002b rotate about longitudinal axis C.

Referring now to FIGS. 3A and 3B, an exemplary microemitter array of the invention is depicted of dimension E by F, creating an array of size EF which is available for the transfer of current elements i. As can be seen from the figures, the larger the microemitter array, the larger the current that is able to be transferred. Area EF may be planar or may take any shape necessary to maintain predetermined gap G for current transfer. The microemitter arrays of the invention comprise a plurality of microemitters. Each microemitter is in electrical communication with an electrically conductive, such as a substrate, which either forms, is in electrical communication with, the structure to which it is desired to pass electrical current such as structures 002a and 002b. Elements of current I, depicted as i in FIG. 2C, each pass through a microemitter into the structure to which it is desired to pass electrical current. Electric current i is passed through a gap between each microemitter tip into the structure to which it is desired to pass electrical current. Each microemitter tip is a current transfer feature of the microemitter. The exemplary microemitter structures 010a and 010b are shown as substantially pyramid in shape in the figures, but the microemitter structures may take any shape such as conical, blade or any other structure with a field concentrating feature, such as a tip, acting as a field emitter, and thus a current transfer feature, of the microemitter. Exemplary current transfer features of various microemitter structures, which may be for example the tips of the microemitters, are depicted as callout 26 in the figures of U.S. Pat. Nos. 6,762,543 and 7,256,535, all of which are incorporated herein by reference. The sum of currents i equals the total current I minus any electrical losses in the microemitter current transfer or resistive losses in the conductive path. FIG. 3B depicts a typical microemitter. The embodiment of the microemitter array and microemitters of the invention depicted in FIGS. 3A and 3B are exemplary only. Although pyramid-shaped microemitters are depicted, they may take conical, blade or other shapes, including all shapes depicted in U.S. Pat. No. 6,762,543 B1 and U.S. Pat. No. 7,256,535 B2 which are both incorporated herein by reference.

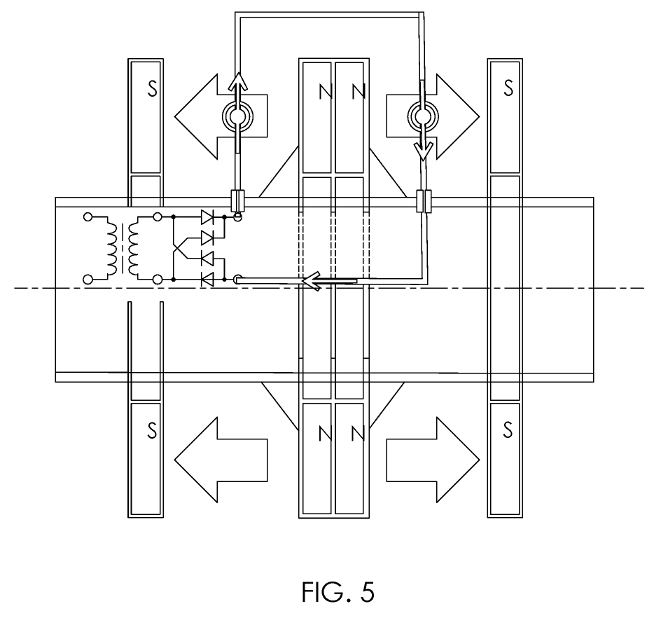

Referring now to FIG. 4, a schematic view of an alternative embodiment of the contact-free current transfer structure of the invention is depicted. Conductive rotor disk 002 comprises rotor shaft 002b. In this embodiment, a larger area of microemitters is achieved by “wrapping” stator electrode 001 around the edge of rotor 002, thus allowing a greater number of microemitters in microemitter array 010a as microemitter array 010a wraps around the edge, and onto the planar surfaces, of rotor 002. This alternative structure enables greater current transfer capacity.

Referring now to FIG. 5, a schematic layout of homopolar machine with rectifier housed inside of the rotating cylinder is depicted.

For wireless transfer of AC currents, an embodiment of the invention is depicted in FIG. 5 as including a rectifier circuit integrated into the rotating system of the homopolar machine. As schematically shown in FIG. 5 the rectifier system can be located in the inside of the cylinder of the drum-type machine. A rotating transformer is used to transfer AC power, which is then rectified.

In any embodiment of the invention, gap G between the current transfer feature (e.g. the microtip) of an emitter and an electrode may be any predetermined gap that enables contactless conduction of current from a microemitter to an electrode. The value of G may be a function of the applied voltage, whether the gap is contained within a vacuum, noble gas, or inert gas, and the acceptable loss. Typically, but not necessarily, gap G may range from 0.5mm to 2.0mm

The various embodiments of the invention shown and described herein are exemplary only and are therefore themselves not exhaustive of the invention as described and claimed.

What is claimed is:

1. A contactless electric current transfer structure for communicating electric current between two structures that are able to be translated or rotated relative to one another, comprising:
a first structure having a plurality of microemitters forming a microemitter array, each microemitter defined has having a current transfer feature;
a second structure having a conductive surface forming an electrode; and
a magnetic field defined by magnetic lines of flux;
wherein a predetermined gap exists between the current transfer feature of each microemitter and said electrode such that contactless electric current transfer is able to occur between said microemitter and said electrode; and
wherein said first structure is capable of being rotated or translated relative to said second structure such that, during said rotation or translation, said predetermined gap between the current transfer feature and said electrode is maintained

2. The contactless electric current transfer structure of claim 1, wherein said microemitters comprise diamond material.

3. The contactless electric current transfer structure of claim 1, wherein said microemitters comprise any material having an operating voltage between 0.5V and 0.7V and emission current density between 100 A/cm² and 300 A/cm².

4. The contactless electric current transfer structure of claim 1, wherein said gap is between 0.5mm and 2.0mm

5. The contactless electric current transfer structure of claim 1, further defined as being contained within a vacuum.

6. The contactless electric current transfer structure of claim 1, further defined as being contained within a chamber filled with an inert or noble gas.

7. The contactless electric current transfer structure of claim 1, further comprising an electromagnet operable to provide said magnetic field, said electromagnet having a solenoidal field winding configuration.

8. The contactless electric current transfer structure of claim 1,
further comprising an electromagnet operable to provide said magnetic field, said electromagnet having a solenoidal field winding configuration;
wherein said microemitters comprise diamond material;
wherein said gap is between 0.5mm and 2.0mm; and
wherein said first structure and said second structure are contained within a vacuum.

9. The contactless electric current transfer structure of claim 1,
further comprising an electromagnet operable to provide said magnetic field, said electromagnet having a solenoidal field winding configuration;
wherein said microemitters comprise any material having an operating voltage between 0.5V and 0.7V and emission current density between 100 A/cm² and 300 A/cm²;
wherein said gap is between 0.5mm and 2.0mm; and
wherein said first structure and said second structure are contained within a vacuum.

10. The contactless electric current transfer structure of claim 1,
further comprising an electromagnet operable to provide said magnetic field, said electromagnet having a solenoidal field winding configuration;
wherein said microemitters comprise any material having an operating voltage between 0.5V and 0.7V and emission current density between 100 A/cm² and 300 A/cm²;
wherein said gap is between 0.5mm and 2.0mm; and
wherein said first structure and said second structure are contained within a chamber filled with an inert or noble gas.

11. A homopolar machine, comprising:
a magnetic field having magnetic lines of flux;
a conductive rotor; and
a stator;
wherein said rotor comprises electrically conductive material and is in electric communication with a rotor electrode through a contactless electric current transfer structure; and
wherein said stator is in electric communication with the rotor through a contactless electric current transfer structure; and
wherein each contactless electric current transfer structure comprises a microemitter array in electric communication with an electrode, wherein said microemitter array is comprised of a plurality of microemitters, each microemitter having a current transfer feature that is separated from a surface of said electrode by a predetermined gap that is operable to conduct current from said microemitter to said electrode in the presence of an applied voltage; and
wherein when an electric current is passed through a rotor electrode into said rotor, along the rotor and into the stator though a stator microemitter array, the a portion of the electric current has a direction of current path that is substantially orthogonal to said magnetic lines of flux; and
wherein said rotor is operable to rotate or translate relative to said stator such that said predetermined gap is maintained while said rotor rotates or translates relative to said stator.

12. The homopolar machine of claim 11, wherein said rotor rotates about a fixed axis.

13. The homopolar machine of claim 11, wherein a portion of the path of current I through said rotor is substantially orthogonal to said lines of magnetic flux.

14. The homopolar machine of claim 12, wherein a portion of the path of current I through said rotor is substantially orthogonal to said lines of magnetic flux.

15. The homopolar machine of claim 11 wherein said microemitters comprise diamond.

16. The homopolar machine of claim 11 wherein said microemitters comprise of any material having an operating voltage between 0.5V and 0.7V and emission current density between 100 A/cm² and 300 A/cm².

17. The homopolar machine of claim 11 wherein said predetermined gap is further defined to be a separation of between 0.5 and 2.0 mm

18. The homopolar machine of claim 11 wherein said contactless electric current transfer structures are contained within a vacuum.

19. The homopolar machine of claim 11 wherein said contactless electric current transfer structures are contained within a chamber filled with an inert or noble gas.

20. The homopolar machine of claim 11, wherein the transfer of electric current through said electric current transfer structures is formed at least impart by plasma current transfer.

21. The homopolar machine of claim 11, further defined as a motor, and wherein the application of a voltage across said rotor electrode and said stator microemitter array, causes an electric current to flow in said rotor, and wherein at least a portion of said electric current is substantially orthogonal to said magnetic flux lines.

22. The homopolar machine of claim 21, wherein said rotor is a disk configuration.

23. The homopolar machine of claim 21, wherein said rotor is a drum configuration.

24. The homopolar machine of claim 11, further defined as a generator, and wherein the application of a rotating force to said rotor causes an electric current to flow in said rotor, wherein at least a portion of said electric current is substantially orthogonal to said magnetic flux lines.

25. The homopolar machine of claim 24, wherein said rotor is a disk configuration.

26. The homopolar machine of claim 24, wherein said rotor is a drum configuration.
